(19) United States
(12) Patent Application Publication
(10) Pub. No.: US 2026/0346809 A1
(43) Pub. Date: Nov. 5, 2026

(54) ASSEMBLY FOR A SEAT BELT RETRACTOR AND METHOD FOR DECOUPLING A DRIVE WHEEL FROM A BELT REEL OF A SEAT BELT RETRACTOR

(71) Applicant: ZF AUTOMOTIVE GERMANY GMBH, Alfdorf (DE)

(72) Inventors: David SCHMELZ, Mutlangen (DE); Bartholomäus BRYLKA, Mannheim (DE); Andreas PREGITZER, Ellenberg (DE); Thomas MÖDINGER, Alfdorf (DE); Steffen DAMBACHER, Abtsgmünd (DE)

(21) Appl. No.: 19/486,197

(22) PCT Filed: May 17, 2024
(86) PCT No.: PCT/EP2024/063755

§ 371 Date: Nov. 20, 2025

(30) Foreign Application Priority Data
May 23, 2023 (DE) 10 2023 113 403.5

(51) Int. Cl. B60R 22/46

(52) U.S. Cl. CPC B60R 22/4676; B60R 22/4628

(57) ABSTRACT

The invention relates to a subassembly (28) for a seatbelt retractor (10) of an automotive vehicle comprising a belt reel (14), a belt tensioner (16) and a drive gear (24). The drive gear (24) is connected to the belt reel (14) via shear elements (26) for torque transmission. Accordingly, at least two shear elements (26) which are adapted to yield from a predefined load level are provided between the drive gear (24) and the belt reel (14). Each shear element (26) engages with a corresponding opening (34, 36) in the belt reel (14). A first opening (34) in the belt reel (14) has a smaller arc length than the second opening (36).

### TECHNICAL FIELD

The invention relates to a subassembly for a seatbelt retractor of an automotive vehicle and to a method of disconnecting a drive gear from a belt reel of a seatbelt retractor.

### BACKGROUND

Seatbelt retractors are well-known and are used to provide a seatbelt for an occupant of a vehicle. In normal operation, the vehicle occupant can unwind the seatbelt freely from the belt reel to buckle up. The belt reel freely supported within a frame winds up the seatbelt again when the vehicle occupant unfastens the seatbelt, for example.

Depending on external parameters such as the deceleration of the vehicle or a high angular acceleration of the belt reel when webbing is unwound, a blocking mechanism is actuated. In this way, a stop gear is supported on the frame so as to prevent rotation. By the blocked stop gear, the belt reel is connected to the frame of the belt retractor in a rotationally fixed manner or is blocked, respectively, and no more seatbelt can be unwound from the belt reel until a predefined load level is reached.

Usually, a belt tensioner that is activated if needed to eliminate a belt slack of a seatbelt and to pre-tension the seatbelt is associated with seatbelt retractors. For this purpose, a drive gear which engages in the belt reel is supported between the belt reel and the belt tensioner. When the belt tensioner is activated, the drive gear is driven via a load transmitting element. The torque-transmitting connection between the drive gear and the belt reel helps also drive the belt reel in a winding direction of the seatbelt.

A load limiter which yields once a load limit is exceeded is disposed between the stop gear and the belt reel. The load limiter can be a torsion rod disposed inside the belt reel. When the load limit is exceeded, the torsion rod is twisted, causing load peaks in the seatbelt to be reduced which would otherwise severely strain the vehicle occupant. In other words, the load limiter allows the belt reel to rotate relative to the frame under the effect of the tensile force of the seatbelt, although the stop gear is supported on the frame so as to prevent rotation.

In the ideal case, when the belt tensioner is activated, the seatbelt is pre-tensioned with a load at a level close to the load limit of the load limiter, i.e. the load level from which the load limiter enables the belt reel to rotate in the unwinding direction.

In order to allow the load limiter to become active after pre-tensioning the seatbelt, it is necessary that the connection between the drive gear and the belt reel is cut, and thus the drive gear is disconnected from the belt reel. The drive gear can be disconnected either in the winding direction and, resp., in the forward direction, or against the winding direction and, resp., in the backward direction. For successful backward disconnection, usually a lower torque is required than for forward disconnection.

It is the object of the present invention to ensure disconnection of the reel from the drive gear both for a forward disconnecting torque and for a backward disconnecting torque.

### SUMMARY

This object is achieved, according to the invention, by a subassembly for a seatbelt retractor of an automotive vehicle comprising a belt reel, a belt tensioner and a drive gear connected to the belt reel via shear elements for torque transmission. At least two shear elements which are adapted to yield from a defined load level are provided between the drive gear and the belt reel. Each shear element engages with a corresponding opening in the belt reel, first openings in the belt reel having a smaller arc length than second openings.

The invention ties up to the fact that the required disconnection torque for backward disconnection is lower than for forward disconnection, provided that the different shearing levels are known. The required disconnection torque for the backward disconnection is reduced, but that for a forward disconnection is not. Reduction of the entire disconnection torque would result in the connection between the tensioner and the belt reel being interrupted at a time when the tensioner rotates the belt reel at a high torque in a winding direction. Consequently, a too early stop of the seatbelt winding would result from the forward disconnection torque. A too high disconnection torque would result in the fact that the drive gear is not completely disconnected from the belt reel. When the webbing is unwound in the subsequent load-limiting phase, the disconnecting elements can cause excessive increase in load until they fail.

Forward and backward in the following always refer to the area of the shear element upon which the load for disconnection acts and, respectively, of the component by which said load is applied. During forward rotation, such load comes from the driven drive gear so that the shear elements abut on a front edge of the openings of the belt reel, during backward rotation the load comes from the belt reel which continues rotating due to its inertia while the drive gear is fixed so that now the shear elements abut on a rear edge of the opening.

Advantageously, at least two first openings and two second openings are provided so that in particular the efficient thickness of the shear elements can be reduced.

Depending on the manufacturing process and/or on the material of the shear elements, even more than two or, resp., four shear elements may be provided.

Two different disconnection torques which are different by the number of active shear elements are achieved by two different scenarios of load transmission\hat{ }\hat{ }\hat{ }\hat{ }\hat{ }\hat{ }.

In a first scenario, when the belt tensioner is activated and, thus, when the drive gear is rotated in the winding direction, all shear elements simultaneously contact a front edge of the respective corresponding opening and, therefore, are actively involved in the load transmission from the drive gear to the belt reel. In this way, a high torque can be transmitted from the drive gear to the belt reel. When a torque is sufficiently high, the shape and the configuration of the front edge of the openings finally result in shear failure of all shear elements at the same time so that the belt reel is disconnected from the drive gear. Consequently, for successful disconnection, a forward torque that causes all shear elements to yield at the same time is required.

In a second scenario, the drive gear is blocked, wherein the belt reel continues rotating due to its inertia. In this way, only part of the shear elements, e.g. two out of the four shear elements, contacts a rear edge of the corresponding opening. This is due to the different arc length of the two first openings and the two second openings. However, because of the shape, the shear elements contact the rear edge of the opening not with their side face but only with a part of the latter. Moreover, the backward disconnection torque can be reduced even further by the shear elements contacting not the full surface of the rear edge, but by making the contact at the tip only. In doing so, the shear elements are bent to break. Thus, the required torque for disconnection in the backward direction is significantly reduced. Only after said shear elements have yielded, by a further rotation of the belt reel the remaining shear elements get in contact either individually or in pairs with the rear edge of the second openings, until also the latter yield. Successive shearing of the shear elements in addition reduces the required torque for disconnection in the backward direction. This applies in particular when more than two shear elements are provided. Accordingly, an arrangement in which the shear elements are designed and disposed, respectively, so that they are shorn step by step is advantageous.

Consequently, for disconnecting the drive gear from the reel it is necessary when the drive gear rotates in the forward direction that all four shear elements yield simultaneously, while in the event of a backward rotation the shear elements yield either one after the other or in pairs. Therefore, in the forward direction, the shearing moment must be overcome simultaneously by all shear elements, while in the backward direction the shear element must be overcome only by a part of the shear elements at a time. Therefore, the disconnection torque, namely the torque level for backward disconnection, is lower.

In order to further reduce the backward disconnection torque, each opening includes a rear edge that has an angle of inclination. The rear edges of the openings thus are not perpendicular to the base of the openings, as it is the case with the front edges which are contacted during forward rotation.

The rear edge of the first openings and that of the second openings particularly have two different angles of inclination. The rear edges of the first openings have an angle of inclination α between 0° and 20°, in particular between 15° and 20°. The rear edges of the second openings have an angle of inclination β that is larger than the angle of inclination α, specifically it is 45°.

Due to the angles of inclination α and β, in addition to the shear load, as it is the case for forward disconnection, also a bending load acts upon the shear elements during backward disconnection; in the second scenario, said bending load results in the fact that the shear elements yield and break.

Preferably, the two second openings are designed as two identical slotted holes with the same arc length. The arc length of the two second openings specifically amounts to 8°. Due to the two second openings which are in the form of slotted holes, the torque required to bend the bolts until they fail is more than 50% lower than the forward torque.

In addition, the two second openings are arranged substantially diametrically opposite each other on the belt reel. In particular, the two second openings are exactly diametrically opposite, i.e. on an axis that passes through a center of the belt reel. When the two second openings are arranged only substantially diametrically opposite each other, then it is not necessary that the centers of the openings are located on an axis that passes through the center of the belt reel. When the two second openings are arranged diametrically opposite each other on the belt reel, both shear elements must yield simultaneously for successful disconnection, whereas the shear elements can yield one after the other, when the two second openings are arranged only substantially diametrically opposite each other.

The drive gear preferably includes an even number of shear elements having a circular cross-section. The circular cross-section enables the shear elements to engage with the openings of the belt reel in an accurately fitting manner. An even number of shear elements allows them to yield in pairs and, thus, the required torque for shearing to be halved.

Preferably, all shear elements have the same diameter. Consequently, the force that has to be applied for shearing is the same for all shear elements.

The shear elements preferably are formed integrally with the drive gear. This results in the manufacturing costs to be reduced and an additional assembly step to be dropped. Therefore, only one single extrusion press is required for extruding the drive gear and the shear elements.

Preferably, a load transmitting element of the belt tensioner can act upon the drive gear and, thus, drive the belt reel, wherein the drive gear is blocked by the load transmitting element at the end of the tension path. As the load transmitting element engages with the drive gear, the belt reel is driven in the winding direction of a seatbelt. By keeping the load transmitting element in engagement with the drive gear, a sufficiently high torque is transmitted so that already the forward rotation causes all four shear elements to yield. In this way, the load transmitting element and the drive gear are disconnected from the belt reel so that for subsequent load limitation, the load transmitting element does not affect the resistance of the belt reel. As a result, also overloading of the seatbelt during and after pre-tensioning is prevented.

Apart from the load transmitting element, the belt tensioner specifically comprises a gas generator which generates drive gas when the belt tensioner is activated. The load transmitting element is moved toward the drive gear by the pressure generated by burning off the propellant.

In embodiment, a stop for the load transmitting element is provided in the subassembly. The stop ensures that, if the belt reel has very low resistance, such as if the belt reel is freely rotatable or if there is a large belt slack, the belt reel is decelerated and stopped. In a second step, the stop results in the fact that the load transmitting element and, thus, also the drive gear come to a standstill so that the belt reel continues rotating because of its inertia, the belt reel rotates relative to the drive gear and the shear elements abut against the rear edge of the opening and ultimately yield.

If the belt reel has a low resistance, the load transmitting element reaches the stop at a very high velocity. At the stop, the load transmitting element then is suddenly strongly decelerated. This results in the rotation of the belt reel relative to the drive gear which entails a sudden load reversal at the shear elements so that the forward disconnection torque turns into a backward disconnection torque. The required disconnection torque of the shear elements is lower in the reverse direction than in the forward direction, because the shear elements were weakened already by the preceding load as the drive gear was strongly accelerated by the load transmitting element. That is, in the backward disconnecting operation, the shear elements yield due to the changed application of force from forward to backward.

According to the invention, also a method of disconnecting a drive gear from a belt reel is provided. To this effect, in a first scenario in which the load transmitting element engages with the drive gear and the load transmitting element does not contact the stop, all four shear elements are contacted simultaneously by the front edge of all corresponding openings. All four shear elements yield so that the drive gear is disconnected from the belt reel.

In a second scenario in which the load transmitting element suddenly blocks and stops the drive gear while or, respectively, after the load transmitting element contacts the stop, all shear elements are contacted by the rear edges of the corresponding first and, resp., second opening so that the shear elements are loaded beyond their load limit and yield. Consequently, the drive gear is disconnected from the belt reel.

The first scenario is also referred to as forward disconnection, the second scenario is also referred to as backward disconnection.

The first scenario occurs whenever a counter-load acts upon the webbing to be retracted and, as a consequence, the torque between the drive gear and the belt reel is increased until the drive gear disconnects in the forward direction, i.e. all shear elements fail synchronously. This occurs, for example, when there is little belt slack and/or the vehicle occupant exerts high load on the seatbelt. The counter-load which in this case acts upon the belt reel counteracts the load which the load transmitting element transmits to the drive gear. Since the drive gear is decelerated by the resistance occurring on the belt reel, also the load transmitting element is equally decelerated. As a result, the gas pressure in the pressure pipe and, in turn, the torque on the shear elements increases in the forward direction until the latter shear off.

The second scenario always occurs when a smaller counter-load acts upon the webbing, i.e. a large belt slack is present or the belt reel can rotate freely, for example. In such a case, the load transmitting element is accelerated unhindered and impacts the stop non-braked. Since the load transmitting element at this moment continues engaging with the drive gear, it blocks the latter. Due to the high torque which is transmitted via the load transmitting element to the drive gear and, thus, to the belt reel, after blocking the drive gear, the belt reel has an inertia which results in the shear elements contacting the back of the openings either in pairs or one after the other. The backward disconnection torque causes the shear elements to finally yield either in pairs or one after the other so that the drive gear is disconnected from the belt reel.

The deceleration moment of the load transmitting element is limited by the material properties of the load transmitting element and the impact velocity. The slower the impact, the softer the load transmitting element and the higher the belt force acting during the impact, the lower also the backward torque that acts upon the shear elements.

Preferably, the two shear elements which correspond to the two second openings are contacted time-shifted relative to the two shear elements from the back side of the second openings and yield. In particular, the two second shear elements break off as a result of bending, and the drive gear and the belt reel are disconnected.

The method in this way helps prevent excessive load increase during the load limiting phase, before the load limiter is active.

### BRIEF DESCRIPTION OF THE DRAWINGS

Further advantages and features of the invention can be seen from the following description and from the attached drawings that are referred to and wherein:

FIG. 1 shows a seatbelt retractor comprising a subassembly according to the invention,

FIG. 2 shows the subassembly according to the invention in a side view after the belt tensioner is activated,

FIG. 3 shows a belt reel of FIG. 1,

FIG. 4 shows a drive gear of the subassembly of FIG. 1 comprising four shear elements,

FIG. 5 shows a subassembly according to the invention of the belt reel of FIG. 3 and the drive gear of FIG. 4,

FIG. 6 shows a section across a first shear element in a first opening of the belt reel and a second shear element in a second opening of the belt reel of FIG. 3,

FIG. 7 shows a schematic view of the subassembly of FIG. 2 in a first scenario,

FIG. 8 shows a schematic view of the belt reel and shear elements in the first scenario,

FIG. 9 shows a schematic view of the subassembly of FIG. 2 in a second scenario,

FIG. 10 shows a schematic view of the belt reel and all four shear elements in the second scenario,

FIG. 11 shows a schematic view of the belt reel and two shear elements in the second scenario.

### DESCRIPTION

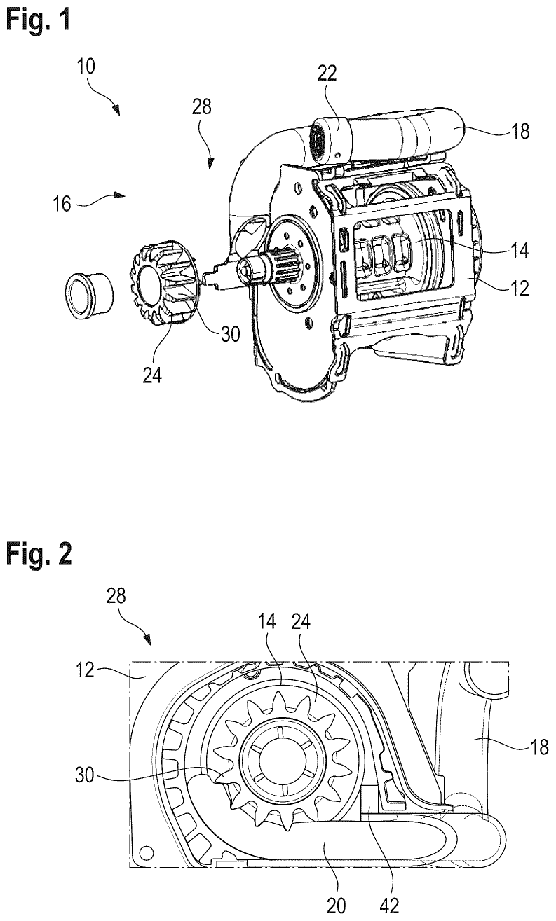

FIGS. 1 and 2 illustrate a seatbelt retractor 10 comprising a frame 12. A belt reel 14 is rotatably arranged in the frame 12.

A seatbelt (not shown) which can restrain a vehicle occupant in case of need can be received on the belt reel 14. For convenience, components such as a locking mechanism or a retractor spring are not shown, as they are not relevant to the comprehension of the invention.

A belt tensioner 16 which includes a pressure pipe 18 is provided on the seatbelt retractor 19. A load transmitting element 20 is received in the pressure pipe 18. The load transmitting element 20 is a flexible plastic rod.

When a schematically indicated gas generator 22 is actuated, the load transmitting element 20 is moved out of the pressure pipe 18 so that it engages with and carries a drive gear 24. The load transmitting element 20 engages with the teeth 30 of the drive gear 24 so that the drive gear 24 is driven in the winding direction and thus forward in this case.

The drive gear 24 is connected in torque-transmitting engagement via the shear elements 26 to the belt reel 14. Therefore, when the belt tensioner 16 is actuated, the belt reel 14 is driven in a winding direction. By the connection of the drive gear 24 via the shear elements 26 with the belt reel 14, also the belt reel 14 is driven in the winding direction of the webbing.

The teeth 30 on the outside of the drive gear 24 ensure friction and positive locking with the load transmitting element 20.

The belt reel 14, the belt tensioner 16 and the drive gear 24 jointly form a subassembly 28.

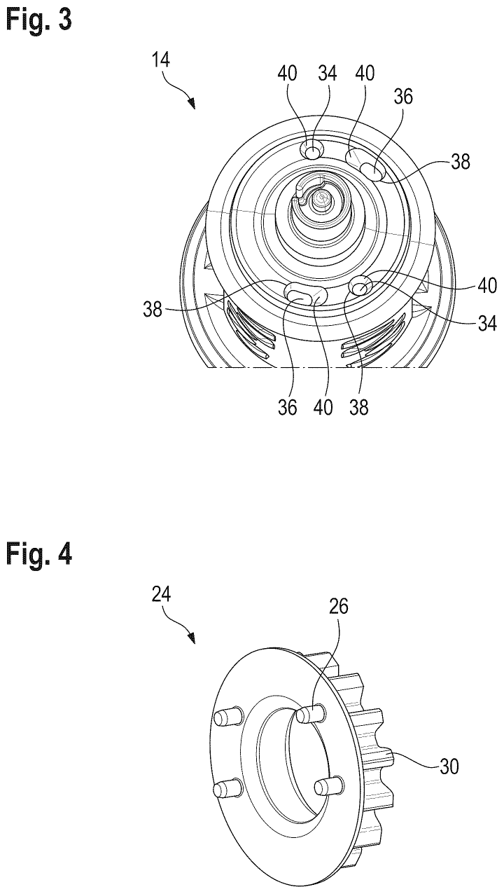

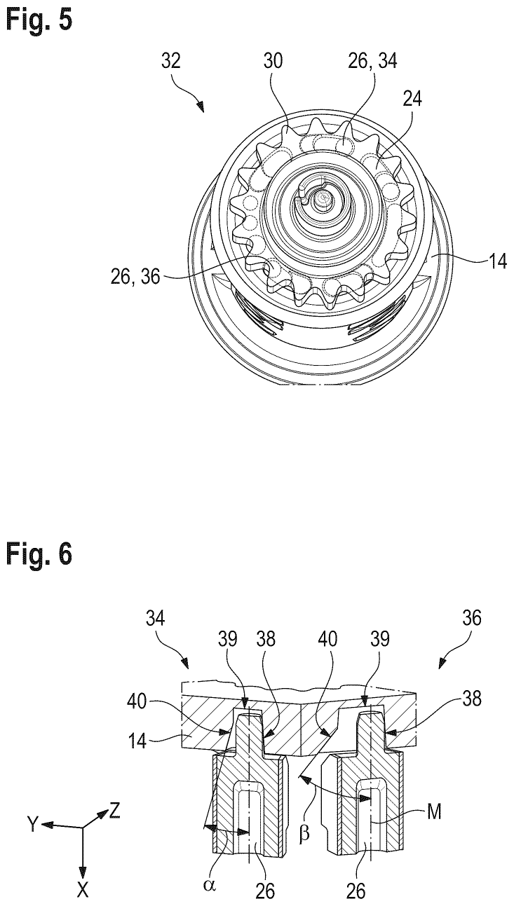

FIGS. 3 to 6 illustrate the belt reel 14 and the drive gear 24, respectively. These two components constitute the disconnecting device 32 for disconnecting the drive gear 24 from the belt reel 14.

The belt reel 14 includes two first openings 34 and two second openings 36. The two first openings 34 are in the form of circular holes. The two first openings 34 and the two second openings 36 are located on the front end of the belt reel 14 associated with the drive gear 24. The two second openings 36 are designed as slotted holes and have an arc length of 8°.

In each of the upper half of the front end and the lower half of the front end, the belt reel 14 includes a first opening 34 and a second opening 36. Consequently, each of a first opening 34 and a second opening 36 is located on each side of the front end of the belt reel 14. The four openings 34 and 36 are located substantially diametrically opposite each other on the belt reel 14 of FIG. 3 so that they are distributed on the two halves of the front end and each half includes a first opening 34 and a second opening 36. The two first openings 34 and the two second openings 36, respectively, are not located exactly on an axis that extends through a center of the belt reel.

The drive gear 24 has four shear elements 26. The shear elements 26 are realized in the form of circular pins which engage with the corresponding openings 34 and 36 in the belt reel 14.

The shear elements 26 extend in the axial direction from a front end of the drive gear 24 facing the belt reel 14. The shear elements 26 are formed integrally with the drive gear 24, particularly are cold extruded jointly with the latter. All shear elements 26 have the same diameter.

The shear elements 26 are substantially diametrically opposite each other on the drive gear 24 and thus are distributed on a right and left side of the drive gear 24. The shear elements 26 are not distributed evenly on the drive gear 24. There is always one shear element 26 between two shear elements 26 which correspond to the same openings 34, 36.

One can see from FIG. 6 that all openings 34 and 36 are configured so that a front edge 38 of the opening 34, 36 which is contacted by the shear elements 26 during forward rotation is almost perpendicular to a base 39 of the opening 34, 36 of the belt reel 14.

A rear edge 40 that is contacted by the shear elements 26 during reverse rotation on the other hand has an angle of inclination α or β.

The rear edges 40 of the two first openings 34 have the angle of inclination α that is formed between the front edge 38 of the first opening 34 and a central axis M of a shear element 26. The angle of inclination a amounts to approximately 15°.

The rear edge 40 of the second opening 36 has the angle of inclination β. The angle of inclination β is larger than the angle of inclination α. The angle of inclination β is 45°. This ensures that the two remaining shear elements safely yield during reverse rotation.

It is not the entire rear edge 40 of the first opening 34 and of the second opening 36 that has the angle of inclination α and β, respectively. In a lower area of the rear edge 40, the angle of inclination is almost 0° so that the rear edge 40 is almost perpendicular to the base 39 of the openings 34, 36.

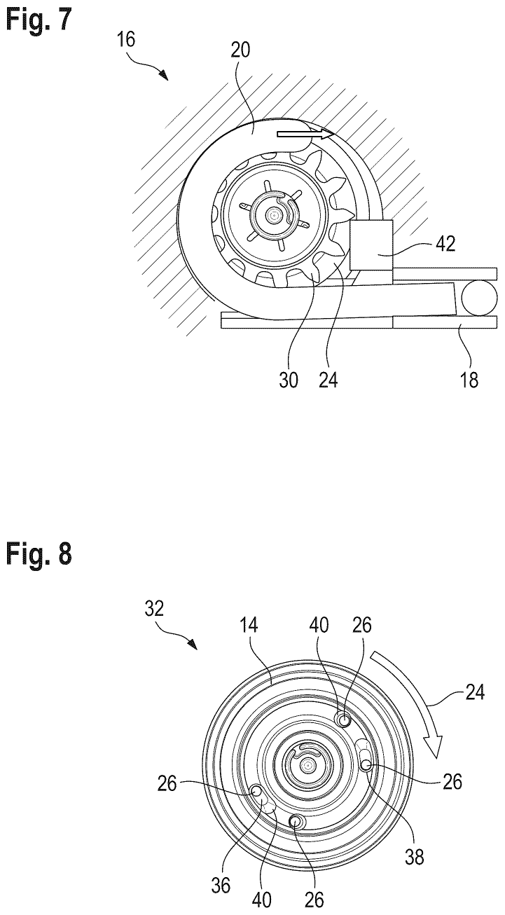

FIGS. 7 and 8 illustrate the belt tensioner 16 in a first scenario. The gas generator 22 was ignited and the belt tensioner 16 was activated. The load transmitting element 20 has been moved out of the pressure pipe 18 by the gas pressure of the burning propellant and now engages with the teeth 30 of the drive gear 24.

In the first scenario, as the drive gear 24 rotates in the winding direction (clockwise in this case), also the belt reel 14 is rotated in the winding direction. All shear elements 26 abut on the front edge 38 of the corresponding openings 34, 36. However, the webbing is subjected to a counter-load (not shown) during rotation of the drive gear 24 so that the belt reel 14 is decelerated. Since the belt reel 14 and the drive gear 24 are connected via the shear elements 26, also the drive gear is decelerated with the load transmitting element. Consequently, the gas volume is increased more slowly so that the gas pressure in the pressure pipe increases due to the continuous burning of the propellant.

The increased gas pressure in the pressure pipe 18 results in the fact that a pressure in the winding direction also acts upon the load transmitting element 20. Said pressure and, respectively, the resulting load is so high that the shear elements 26 will completely shear or break off. Thus, the drive gear 24 is successfully disconnected from the belt reel 14.

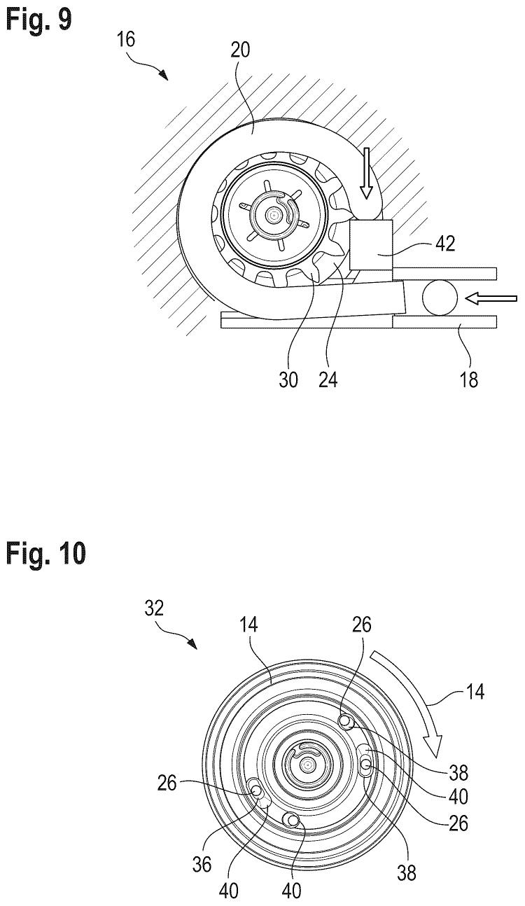

FIGS. 9 to 11 illustrate a belt tensioner 16 and a disconnecting device 32 in the second scenario. In the second scenario, in the absence of resistance, for example due to a freely rotating reel or a large amount of belt slack, the load transmitting element 20 leaves the pressure pipe 18 very quickly so that the resulting lower gas pressure is not sufficient to separate all four shear elements 26 from the drive gear 24 by shear fracture.

Due to the absence of the counter-load, the load transmitting element 20 can be moved up to the stop 42 by the pressure generated by the gas generator 22. The load transmitting element 20 again engages with the teeth 30 of the drive gear 24 and thus rotates the drive gear 24 also in the winding direction (clockwise in this case). The belt reel 14, too, is rotated in the winding direction and the webbing is reeled. During rotation in the winding direction, all four shear elements 26 contact the front edges 38 of the first opening 34 and, resp., of the second opening 36. The strong acceleration of the drive gear 24 already weakens the shear elements 26 so that subsequently they yield more easily.

The load transmitting element 20 usually impacts the stop 42 at high velocity and then experiences sudden and strong deceleration. During said deceleration, a load transmission from the forward direction to the reverse direction acts upon the shear elements 26.

Although the load transmitting element 20 and, thus, also the drive gear 24 are stopped quickly, the belt reel 14 continues rotating in the winding direction due to its inertia.

Continued rotation of the belt reel 14 while the drive gear 24 is fixed by the load transmitting element 20 causes the shear elements 26 to contact the rear edges 40 instead of the front edges 38.

The first openings 34 have a smaller arc length, however, than the second openings 36. Consequently, at first the two shear elements 26 located in the openings 34 impact the respective rear edges 40. The shear elements 26 are bent by the angle of inclination a of the contours of the rear edge 40 until the two shear elements 26 in the two first openings 34 yield. The shear elements 26 in the first openings 34 can yield either simultaneously or successively.

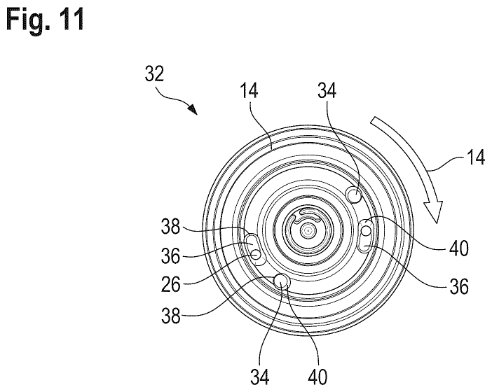

Shortly before the first shear elements 26 break off completely, already the second shear elements 26 get in contact with the corresponding rear edges 40 so that the disconnecting moment acts as continuously as possible until all shear elements have completely failed. FIG. 11 illustrates the disconnection subassembly 32 in the second scenario, where the first two shear elements 26 in the two first openings 34 have yielded already. Due to the yielding of the two shear elements 26 in the two first openings 34, the belt reel 14 continues to rotate slightly due to its inertia. As a result, the two shear elements 26 in the two second openings 36 contact the respective rear edges 40.

Since the angle of inclination β of the rear edge 40 of the second opening 36 is larger than the angle of inclination α of the first opening 34, the amount of load required to break off the two remaining shear elements 26 is lower.

The two remaining shear elements 26 now are urged toward the rear edges 40 of the second opening 36 by the inertia of the belt reel 14 until they yield. As the shear elements 26 were weakened already by the rotation in the winding direction, the load required for backward disconnection is lower and the shear elements 26 fail because of a forward-backward movement.

A method of disconnecting the drive gear 24 from the belt reel 14 is as follows:

In a first step (S1), belt tensioning takes place. The gas generator 22 is actuated, the load transmitting element 20 is moved out of the pressure pipe 18 and engages with the teeth 30 of the drive gear 24 so that the belt reel 14 is moved over the shear elements 26 in the winding direction.

In step 2 (S2), either all four shear elements 26 break off simultaneously due to a resistance at the belt reel 14 and thus disconnect the belt reel 14 from the drive gear 24, or the shear elements 26 are fully or at least partly retained due to the absence of a resistance.

When all shear elements 26 yield, disconnection is completed and step 5 (S5) will follow in which a ratchet engages after a small amount of webbing has been released and the load limiting phase of the torsion rod starts.

If, in step 2, not all four shear elements or even none of the four shear elements 26 is disconnected, step 4 (S4) follows after the load transmitting element 20 has contacted the stop 42 (S3).

If, in the fourth step (S4), all four shear elements 26 are disconnected backward due to the inertia of the belt reel 14, the drive gear 24 is successfully disconnected from the belt reel 14, and step 8 will follow (S8).

It can be ensured by the openings 34, 36 with different arc lengths and the inclined rear edges 40 that all shear elements 26 yield at least in step 4 (S4) so that the drive gear 24 is disconnected from the belt reel 14 and the load limiting phase can start.

1-11. (canceled)

12. A subassembly for a seatbelt retractor of an automotive vehicle comprising a belt reel, a belt tensioner and a drive gear which is connected to the belt reel via shear elements for torque transmission, wherein at least two shear elements which are adapted to yield from a predefined load level are provided between the drive gear and the belt reel, each shear element engaging with a corresponding opening in the belt reel, wherein a first opening in the belt reel has a smaller arc length than the second opening.

13. The subassembly according to claim 12, wherein at least two first openings and two second openings are provided.

14. The subassembly according to claim 13, wherein the two second openings are designed as two identical slotted holes having the same arc length.

15. The subassembly according to claim 13, wherein the two second openings are arranged substantially diametrically opposite each other on the belt reel.

16. The subassembly according to claim 12, wherein the drive gear has an even number of shear elements with a circular cross-section.

17. The subassembly according to claim 12, wherein all shear elements have the same diameter.

18. The subassembly according to claim 12, wherein the shear elements are formed integrally with the drive gear.

19. The subassembly according to claim 12, wherein a load transmitting element of the belt tensioner can act upon the drive gear and drives the belt reel, wherein the drive gear is blocked by the load transmitting element after activation.

20. The subassembly according to claim 12, wherein a stop for the load transmitting element is provided in the subassembly.

21. A method of disconnecting a drive gear from a belt reel of a subassembly according to claim 12, wherein
a) in a first scenario in which the load transmitting element engages with the drive gear and does not contact the stop, all shear elements are contacted simultaneously by a front edge of all corresponding openings and yield so that the drive gear is disconnected from the belt reel, or
b) in a second scenario in which the load transmitting element blocks the drive gear and contacts the stop, all shear elements are contacted by the rear edges of the corresponding first opening or second opening and yield so that the drive gear is disconnected from the belt reel.

22. The method according to claim 21, wherein, in the second scenario, the two shear elements which correspond to the two second openings are contacted time-shifted relative to the two shear elements by a rear edge of the two second openings and yield, in particular break off.
